(19) United States
(12) Patent Application Publication
(10) Pub. No.: US 2011/0175304 A1
(43) Pub. Date: Jul. 21, 2011

(54) ONE-PIECE RUNNING GEAR AND RUNNING ASSEMBLY COMPRISING IT

(76) Inventor: Jean-Claude Arbogast, Harthouse (FR)

(21) Appl. No.: 12/736,621

(22) PCT Filed: Apr. 21, 2009
(86) PCT No.: PCT/FR2009/000470

§ 371 Date: Oct. 22, 2010

(30) Foreign Application Priority Data
Apr. 22, 2008 (FR) 08/02229
Jan. 23, 2009 (FR) 09/00293

(51) Int. Cl. B62D 55/14; B62D 55/24; B62B 5/00

(52) U.S. Cl. 280/28.5; 305/129; 305/165

(57) ABSTRACT

The one-piece running gear (1) has at least two wheels (2), each mounted to rotate about a shaft (6) on a mounting (7). The rotary shaft (6) of at least one of these wheels (2) can be moved away by at least one spacer means (13), the force for returning it to position being exerted by an endless kinematic running link (3) travelling around the wheels (2), said wheels being kinematically connected together by this running link (3). The running gear (1) may be mounted in a pivoting or fixed fashion on a rolling base serving as the chassis of a vehicular or other moving assembly.

The present invention relates to a one-piece running gear of a new type and to a running mobile assembly comprising it, provided so that it can be used in place of any other existing running element: wheel, caster or analogous device.

More particularly, the invention relates to a one-piece running gear formed at least of two casters, whose rotary shafts can be displaced by pushing one away from the other and by pulling them back together under the restoring effect of an endless kinematic running link of the belt type carried in rotation by the casters.

The traditional running gears do not offer sufficient comfort by themselves, and when such comfort is desired the running gears are generally combined with one or more suspensions. These suspensions are bulky, and cannot always be integrated directly into the running gears.

For the running mobile assemblies provided with one or more running gears, for example pieces of furniture mounted on casters, hospital gurneys and beds, child strollers, suitcases, etc., generally no suspension is provided. Thus the casters usually mounted on these mobile assemblies do not allow running in satisfactory manner on terrain that is soft, uneven or cluttered, for example due to gravel. In addition, if they are used on floors that are rough, difficult, damaged or irregular, they generate uncomfortable, dangerous and even harmful vibrations, which are transmitted to the rest of the mobile assembly. These vibrations are very annoying because of the fact that, for example, they are felt by the child seated in the stroller or by the patient being transported in his bed, or are transmitted to objects placed on the caster-mounted furniture, which in this latter case may damage them by shocks or cause them to fall off.

In order to lessen these vibrations, it is known that the contact surfaces of wheels and casters can be lined by a rotating strip of deformable flexible material. However, this solution is only partly satisfactory, especially because it is characterized by premature wear of the rotating strip in contact with the floor.

In addition, the traditional wheels and casters have a tendency to sink into soft floors, which makes their use quite difficult, especially on floors of beaten earth, sand or similar material. Because of this fact, for vehicles that usually have to travel on this type of terrain, the wheels are replaced by tracks. Tracks exhibit numerous disadvantages, especially including wear, reduced speed, greater noise and harmful degradation of the pavement or floor.

Finally, in the case of shopping carts, trolley-type carts and analogous running mobile assemblies, the running gears are rarely adapted to getting past obstacles or to ascending or descending a staircase.

The invention provides a solution by a running means that makes it possible to travel comfortably and silently over any type of terrain and can be adapted to descending and ascending obstacles.

Better running comfort than that provided by the traditional wheels and casters is achieved by virtue of the invention by means of a new one-piece running gear. This one-piece running gear is provided with at least two wheels or casters, each aligned and mounted or carried to rotate around a shaft or via a shaft carried on a mounting. The rotary shaft of at least one of these wheels or casters can be displaced by moving it away by way of a spreading means provided in or on the mounting. This rotary shaft is mounted to be freely displaceable in guided and damped manner over a predetermined course so that it can be automatically displaced during operation in spreading movement by the spreading means under the sole effect of a pressure force on the floor. The spreading means can have the form of an inclined ramp or of an elongated guide slot inclined relative to the horizontal, in the displaceable rotary shaft slides, or the form of a spreading piece or mechanism provided to push the rotary shafts of the wheels or casters apart. The displacement of the rotary shaft of the wheel or caster toward the outside imparts a damping effect, wherein the return to initial position takes place naturally and automatically by the elastic restoring force pulling it back toward the initial position and exerted by an endless kinematic running link, especially of the belt type carried by the wheels or casters, which are then kinematically interconnected by this running link.

The running gear may be mounted pivotally or fixed on a running base serving as chassis for a mobile assembly.

Other characteristics and advantages of the invention will become apparent upon reading the detailed description hereinafter, which description is given with reference to the attached drawings, wherein:

FIGS. 1 to 4 are general views in profile of a simple one-piece running gear according to diverse preferred embodiments and variants of the invention comprising two casters;

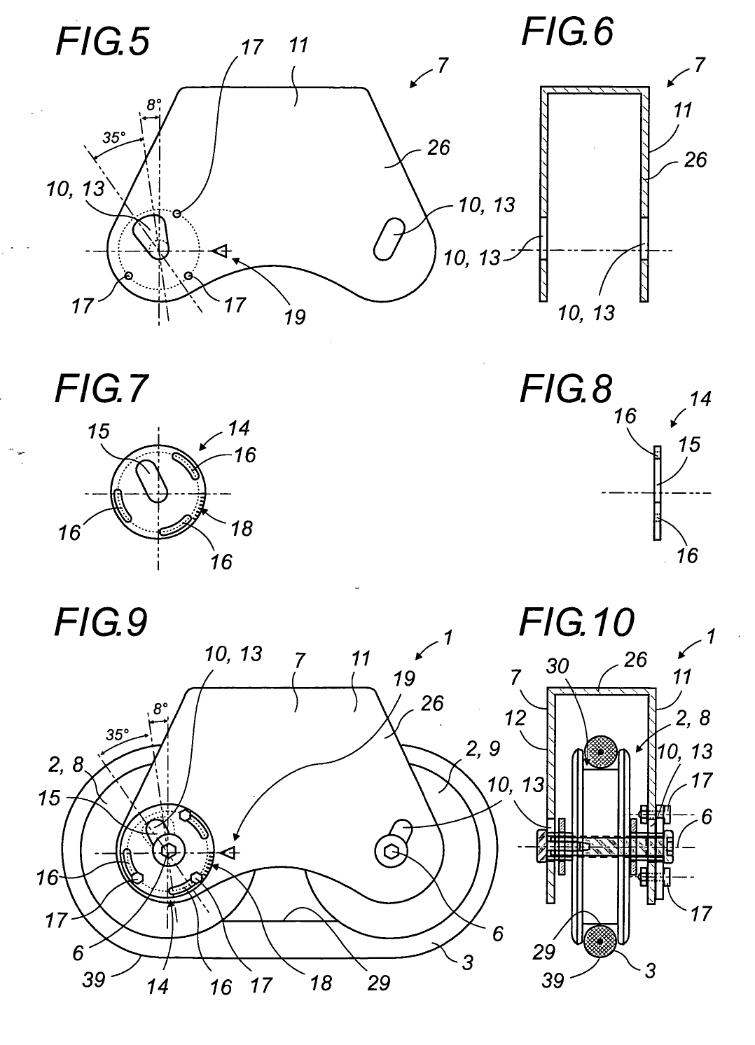

FIGS. 5 to 10 illustrate a variant of the invention comprising a means for adjustment of the inclination of the suspension effect for the rotary shaft of a wheel or caster;

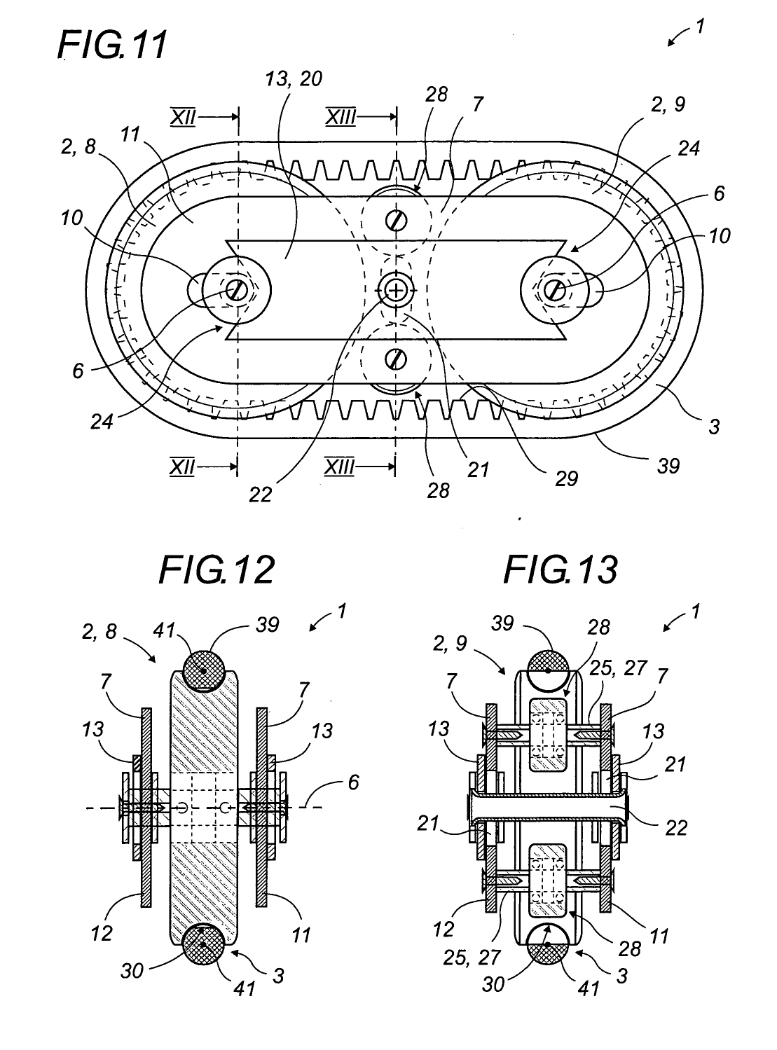

FIG. 11 is a general view in profile of a one-piece running gear according to the second preferred embodiment of the invention comprising two wheels or casters;

FIGS. 12 and 13 are views in vertical section respectively at the level of a wheel or caster and at the level of an intermediate running support of the one-piece running gear of FIG. 11;

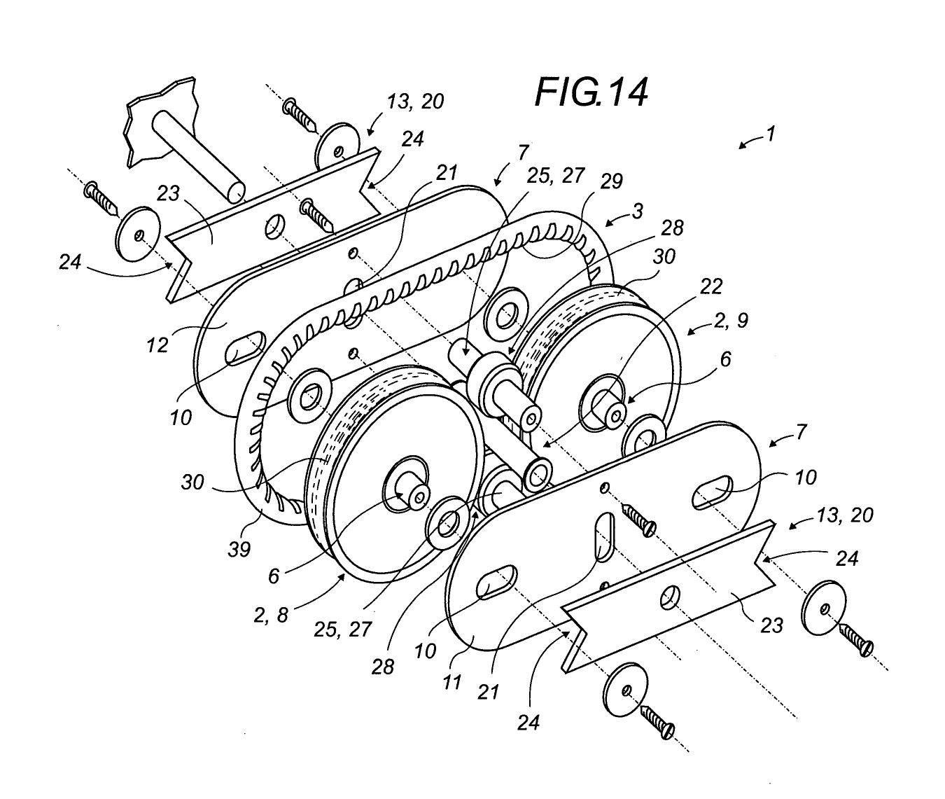

FIG. 14 is a general view dissociated from the one-piece gear of FIG. 11;

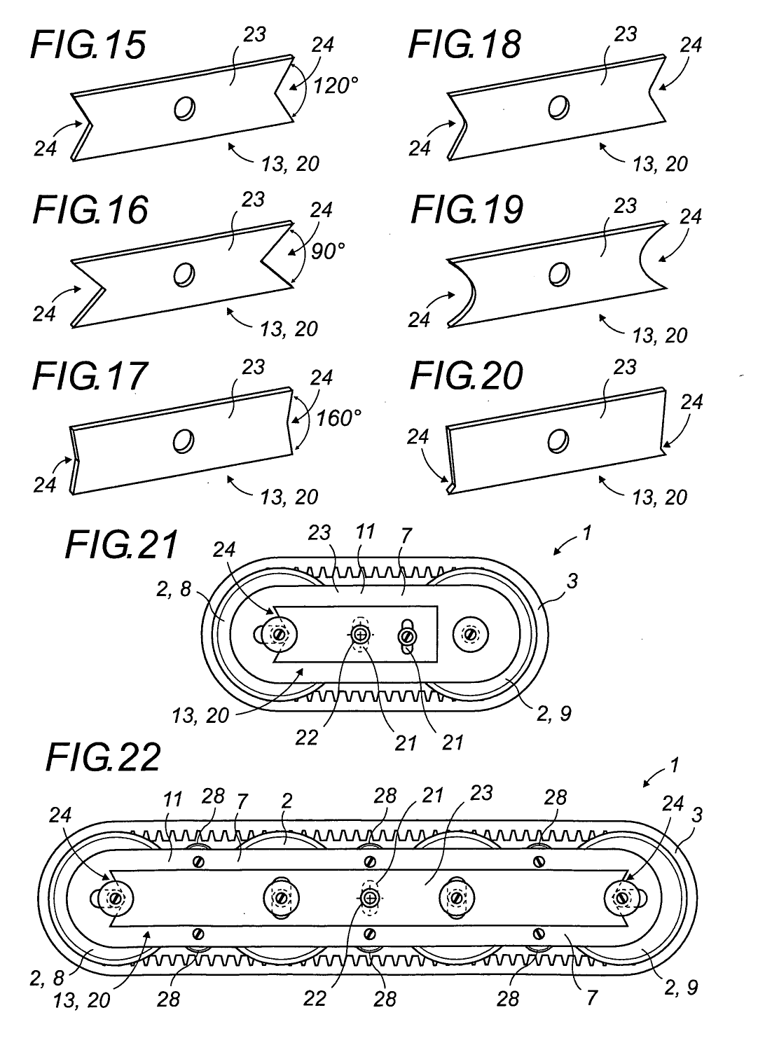

FIGS. 15 to 20 are views in perspective illustrating different variants for the spreading piece of the one-piece running gear according to the second preferred embodiment of the invention;

FIG. 21 is a general view in profile of a variant of the second preferred embodiment of the invention in which the shaft of a single wheel or caster is mounted to be displaceable by means of a spreading piece;

FIG. 22 is a general view in profile of a variant of the second preferred embodiment of the invention in which the running gear is provided with four aligned wheels or casters, the shafts of those at the end being displaceable by means of a spreading piece;

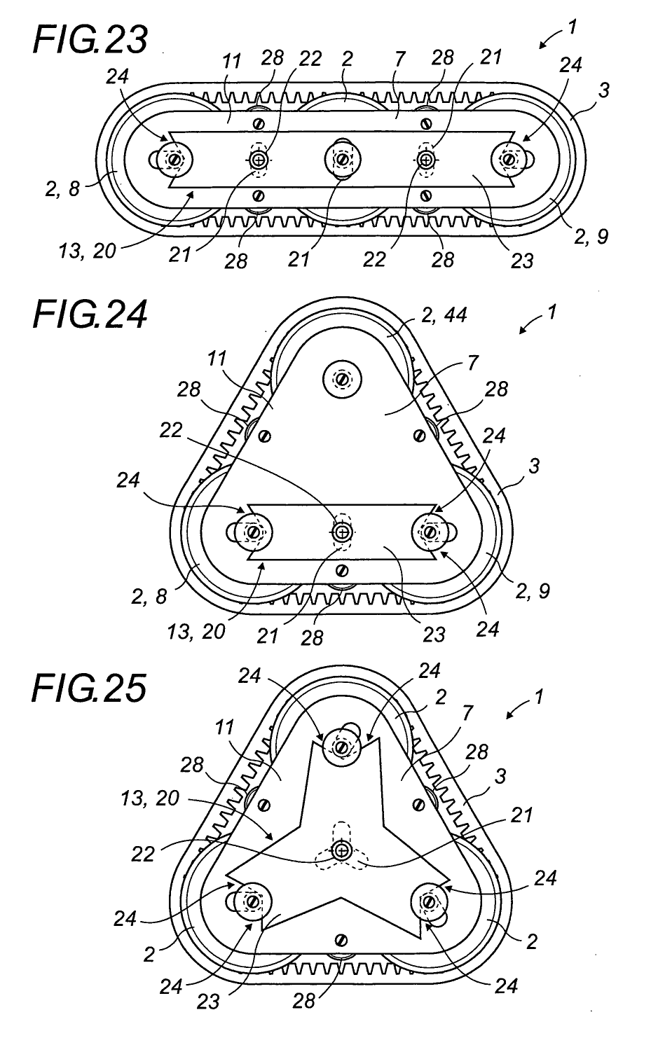

FIG. 23 is a general view in profile of a variant of the second preferred embodiment of the invention in which the running gear is provided with three aligned wheels or casters, the shafts of those at the end being displaceable by means of a spreading piece and the flank pieces of the mounting each having two substantially vertical elongated guide slots;

FIG. 24 is a general view in profile of a variant of the second preferred embodiment of the invention in which a third wheel or caster with fixed shaft is mounted above the other two wheels or casters with displaceable shaft;

FIG. 25 is a general view in profile of a variant of the second preferred embodiment of the invention provided with three wheels or casters whose shafts can be displaced apart by means of a common spreading piece;

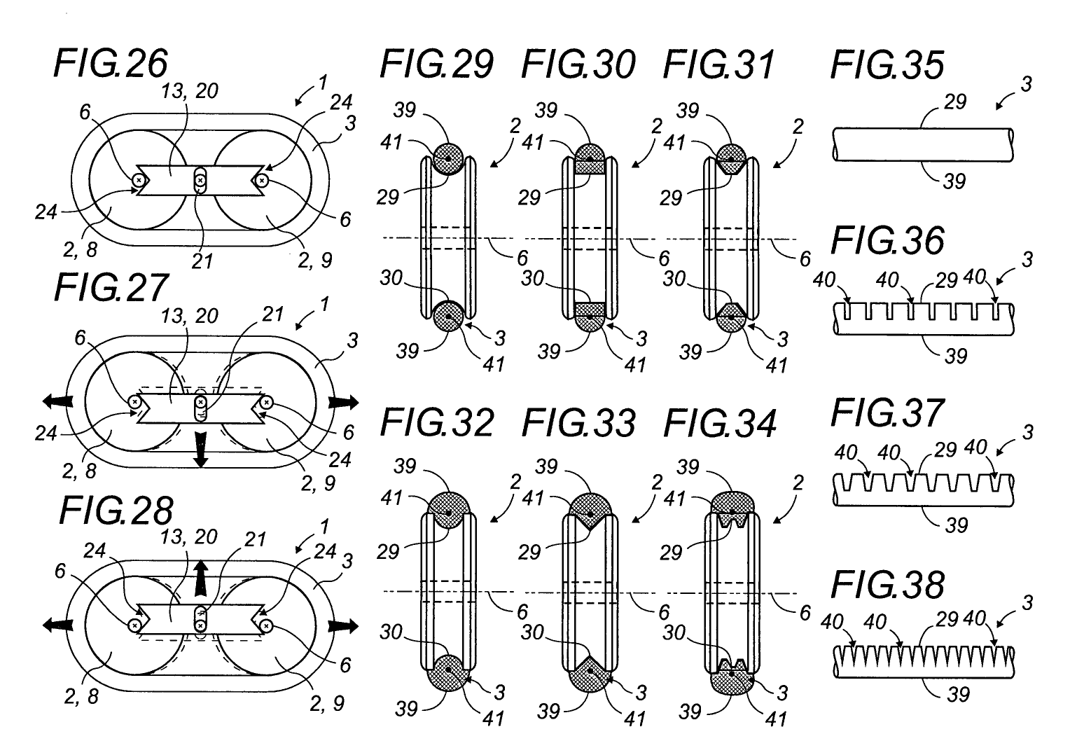

FIGS. 26 to 28 are schematic views in profile of the one-piece gear according to the second preferred embodiment of the invention illustrating the manner in which the spreading piece pushes the rotary shafts of two wheels or casters apart, one hole being represented in the spreading piece for reasons of clarity;

FIGS. 29 to 34 are detail views in cross section between two wheels or casters of the invention and illustrating several examples of different shape for the section of the running link and for the throat of the wheels or casters;

FIGS. 35 to 38 are views in profile of a section of the running link according to different variants of the invention in which this link has an internal face that may or may not be cut into regular transversal notches;

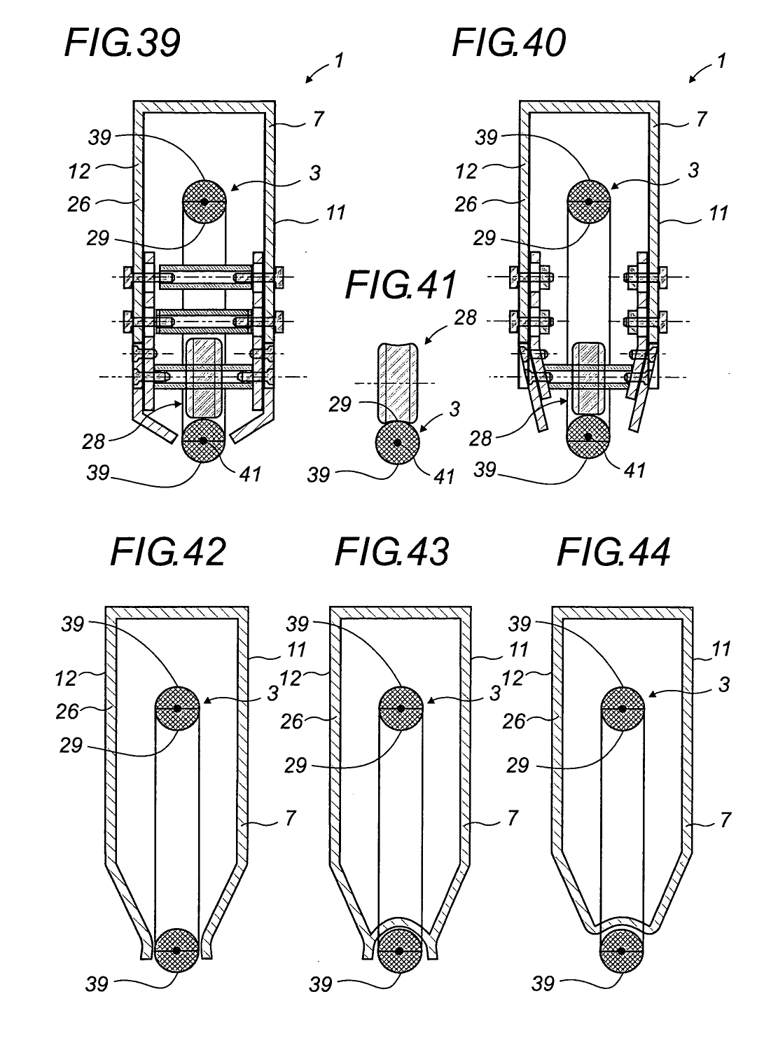

FIGS. 39 and 40 are views in vertical section at the level of a smooth support pulley on the internal face of the running link according to different variants of the invention provided with such a support element;

FIG. 41 is a view in cross section of a support pulley with throat;

FIGS. 42 to 44 are schematic views in cross section of a mounting provided with different variants of lateral guides for the running link;

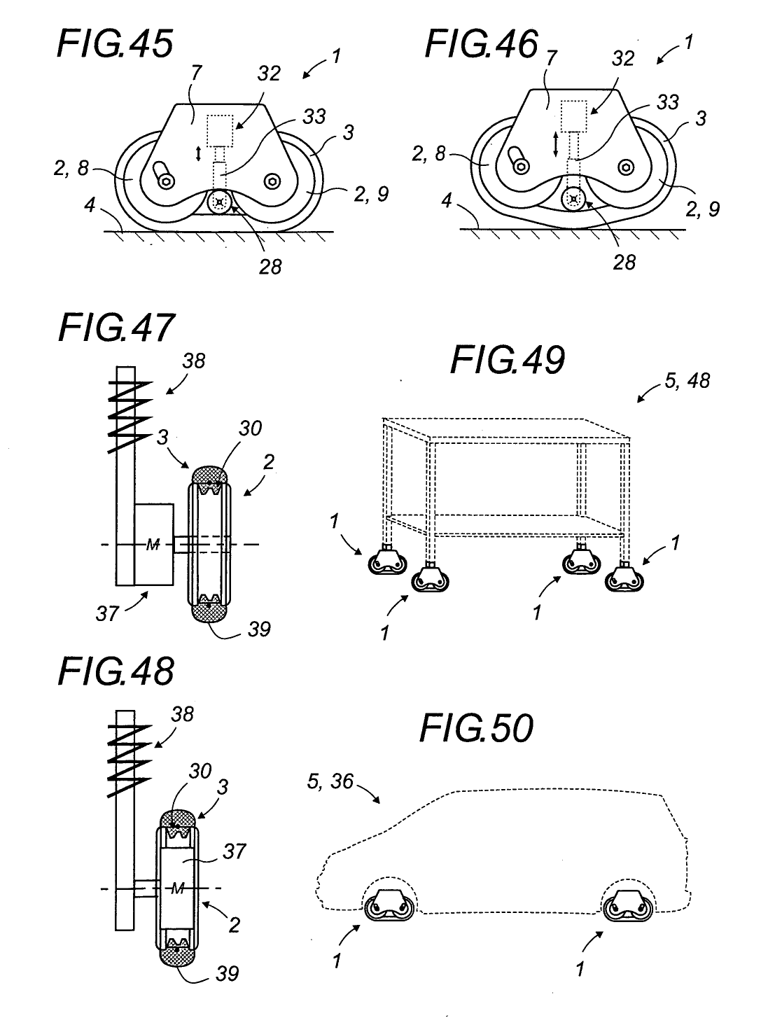

FIGS. 45 and 46 are schematic views in profile of a variant of the invention where the vertical position of the support pulley can be adjusted by jacks;

FIG. 47 is a schematic view representing a wheel or caster according to the invention, which is motorized by an external motor;

FIG. 48 is a schematic view representing a wheel or caster according to the invention, which is motorized by an internal motor in the form of a motor wheel;

FIG. 49 is a schematic general view in perspective of a furniture item on which there are mounted four running assemblies according to the invention in a proportion of one one-piece running gear according to the invention per foot of the furniture item;

FIG. 50 is a schematic view in profile of a vehicle on which running assemblies according to the invention are mounted in place of wheels; and

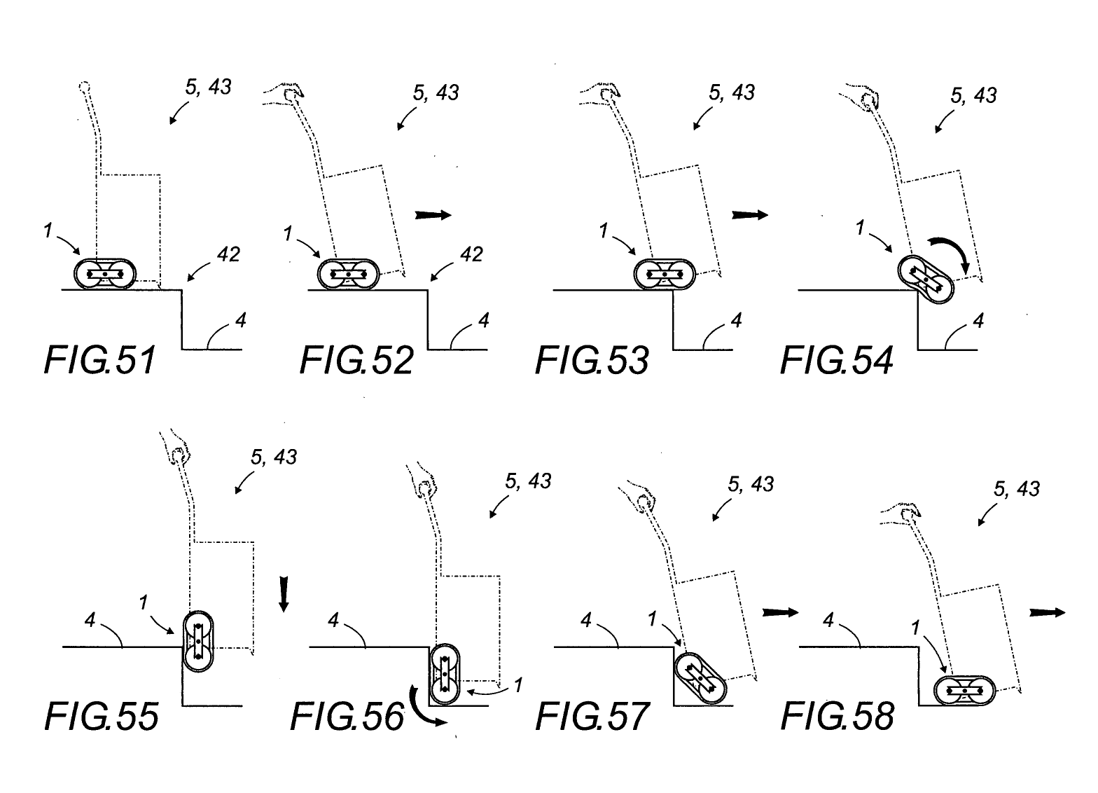

FIGS. 51 to 58 are schematic view illustrating the descent of a staircase by a running assembly provided with two running gears according to the invention.

The one-piece running gear according to the present invention will now be described in detail with reference to FIGS. 1 to 58. Equivalent elements represented in the different figures will be denoted by the same numerical references.

In the interests of simplification, we will designate by wheel in the rest of this description not only a wheel or caster but also any one-piece running or rotating means.

The variants represented in the figures are given merely by way of example and are not to be interpreted restrictively. In the interests of simplification, the majority of the figures represent a one-piece running gear according to a preferred embodiment of the invention. Nevertheless, several variants can be envisioned for the invention. Similarly, the number of elements, such as, for example, the wheels, the shape of the means and their positions are not to be interpreted restrictively. Thus, even if we have limited ourselves to the use of two to four wheels for the invention, it is possible to envision integrating a larger number of wheels in the same one-piece running gear. Similarly, a plurality of one-piece running gears of the invention may be mounted on the same mobile running assembly or assembly displaceable by running.

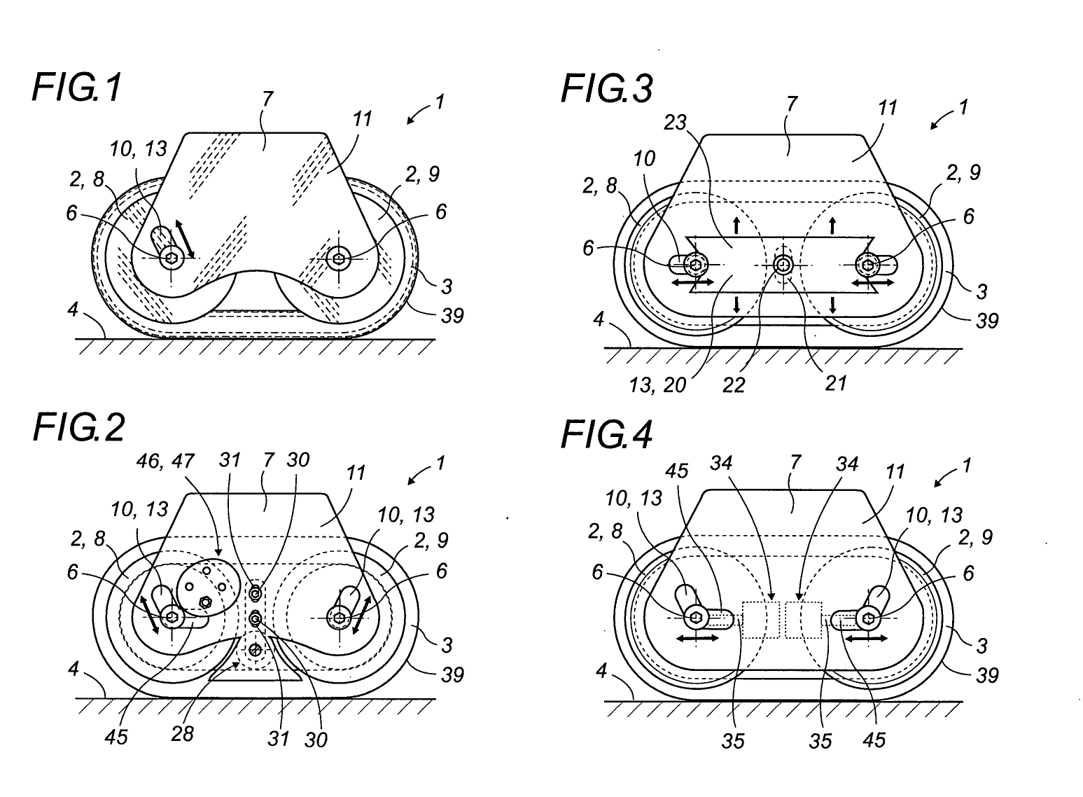

In general, the invention relates to a one-piece running gear 1 of a novel type such as represented in FIGS. 1 and 3 in its simplest variants. This one-piece running gear 1 is provided so that it may be used in place of any other existing running element: wheel, caster or analogous element. It is provided with at least two wheels 2, on which there is carried in rotation a kinematic running link 3 mounted to circulate on them.

Contrary to the traditional mobile running assemblies, the one-piece running gear 1 according to the invention is not made to run directly on the external periphery of wheels 2, but on an endless kinematic running link 3 carried in circulation by the at least two wheels 2 of running gear 1. In fact, with this type of one-piece running gear 1, the bearing surface on floor 4 is larger and linear, and the user is less aware of the unevennesses of floor 4 when he causes mobile assembly 5 with which he is provided to run along.

At least two wheels 2 are mounted to rotate, each around a shaft 6 carried by a mounting 7 and aligned by this mounting 7. Rotary shaft 6 of at least one of end wheels 2, 8, 9, or in other words of front wheels 2, 8 and rear wheels 2, 9, is mounted to be displaceable along a linear course during operation, for example along an elongated guide slot 10 made in flank pieces 11, 12 of mounting 7, on which rotary shafts 6 of wheels 2 are mounted.

FIGS. 2 to 4 illustrate a preferred embodiment of the invention in which rotary shaft 6 of the two end wheels 2, 8, 9 is mounted to be displaceable during operation.

By rotary shaft displaceable during operation there is understood a rotary shaft that can be automatically displaced translationally during use of running gear 1 on which it is mounted, as opposed to a rotary shaft that is displaced during an adjustment, for example an adjustment of the tension of running link 3. In general, such an adjustment is made before use of running gear 1 by displacement of the rotary shaft, after loosening of a screw or of a screw-nut assembly, and then retightening to obtain a fixed position of this shaft. In the invention, rotary shafts 6 are free, meaning that they can be displaced and can do so automatically during operation at any moment under the effect of a force originating from a pressure on running gear 1, with automatic return to the initial position by elastic restoration originating from the kinematic link.

The inventive concept of the invention lies in the fact that rotary shaft 6 of at least one of the end wheels 2, 8, 9 is mounted to be displaceable and that a spreading means 13 is provided to push this displaceable rotary axis 6 apart when this means 13 or mounting 7 is displaced vertically upward or downward under the weight of running mobile assembly 5 on which it is mounted. The return to initial position takes place naturally and automatically by the restoring force exerted by kinematic link 3.

It will be noted that the elastic tension of kinematic running link 3 increases with the weight exerted on spreading means 13. What happens is indeed a damping effect that spontaneously adapts to the weight of running mobile assembly 5 on which it is mounted.

According to a first preferred embodiment of the invention, at least one rotary shaft 6 of wheel 2 is mounted to be displaceable and guided along an elongated guide slot 10 inclined relative to the horizontal and made in flank pieces 11, 12 of mounting 7 on which are mounted rotary shafts 6 of wheels 2. In this case, this elongated and inclined guide slot 9 constitutes spreading means 13 of the invention, in such a way that, when one-piece running gear 1 passes over an uneven floor 4 or an obstacle, rotary shaft 6 of the displaceably mounted wheel, when displaced upward, for example, if elongated guide slot 10, 13 is inclined upward, has a shock-absorbing effect, as represented by a solid arrow in FIG. 1. In this case, the return of displaceable rotary axis 6 of the wheel to position takes place by the elastic restoring effect of the kinematic binding effect supplied by kinematic running link 3. In fact, the latter is preferably mounted stretched on wheels 2 of one-piece running gear 1 and consequently it urges rotary shaft 6 of wheel 2 downward in elongated guide slot 10, 13 made in flank pieces 11, 12 of mounting 7.

When rotary shaft 6 of the displaceably mounted wheel moves upward in elongated guide slot 10, 13 made in flank pieces 11, 12 of mounting 7, the shape of the perimeter of kinematic running link 3 changes temporarily, for example by spatial deformation or by elastic elongation, then returns to its initial shape. Since elongated guide slot 10, 13 is inclined toward the outside, kinematic running link 3 is able to assure all or part of the restoring force necessary for the suspension effect by simple spatial deformation of its perimeter.

The tension of endless kinematic running link 3 maintains each rotary shaft 6 in pulled-together position, for example low position, in elongated guide slot 10, 13, and exerts an elastic resisting and restoring force while it is being pushed apart, for example being displaced upward. Thus displaceable rotary shaft 6 of the wheel can be mounted with a suspension effect without the need to use another means capable of achieving elastic restoration, such as springs or analogous means. This damping effect, augmented by the anti-vibration nature of kinematic running link 3, assures among other aspects great stability for the assembly and a longer service life for the rolling bearings of wheels 2.

Elongated guide slot 10, 13 made in flank pieces 11, 12 of mounting 7 on which wheels 2 are mounted is preferably inclined toward the exterior at a fixed or modifiable angle making it possible to modify, adjustably, the direction of displacement of wheel 2 and the damping force according to the weight of mobile assembly 5 on which the invention is mounted or of the nature of floor 4 on which it is running. In fact, an elongated guide slot 10, 13 having longitudinal direction close to the vertical permits scarcely damped upward movement of wheel 2, particularly suited to mobile assemblies 5 of low weight or to a badly damaged floor 4, whereas an elongated guide slot 10, 13 having inclined or more inclined longitudinal direction brings about more damped and therefore more difficult upward movement thereof by the effect of kinematic link 3, particularly suitable for mobile assemblies 5 of high weight or for a perfectly smooth floor 4.

FIGS. 5 to 10 detail a variant according to which the angle of inclination of elongated guide slot 10, 13 is adjustable. In this variant, there is provided a pivoting adjustment disk 14 having adjustable inclination and exhibiting a guide slot 15 designed for passage of rotary shaft 6 of wheel 2 mounted to slide along this guide slot 15. This pivoting adjustment disk 14 is mounted on mounting 7 at the level of elongated guide slot 10, 13 of at least one displaceably mounted rotary shaft 6. In this variant, mounting 7 has an enlarged guide slot 10, 13, which coincides substantially with guide slot 15 of pivoting adjustment disk 14 in such a way that rotary shaft 6 of wheel 2 passes into enlarged guide slot 10, 13 made in flank pieces 11, 12 of mounting 7 on which wheels 2 are mounted. This pivoting adjustment disk 14 also has holes 16 in the form of arcs of a circle for the passage of guide and clamping screws 17 used to guide the pivoting movement. In this variant, enlarged guide slot 10, 13 made in flank pieces 11, 12 of mounting 7 is provided for the passage and displacement of rotary shaft 6 mounted to be displaceable according to different angles of inclination provided by pivoting adjustment disk 14. Mounting 7 on which shafts 6 of wheels 2 are mounted also has threaded drill holes 17 for the passage of the preceding guide and clamping screws 16. During adjustment, guide and clamping screws 16 are loosened so that the user can orient pivoting adjustment disk 14 according to the chosen inclination. This orientation takes place by pivoting of disk 14, which pivoting is guided by sliding circular-arc-shaped holes 16 of the body of disk 14 over guide and clamping screws 16. Once the inclination has been chosen, pivoting adjustment disk 14 can be immobilized in position by tightening guide and clamping screws 16. The displacement of rotary shaft 6 of wheel 2 during damping will then take place according to the angle of inclination fixed in this way.

This angle of inclination relative to the vertical, for example toward the front, ranges between 0 and 90°, preferably between 0 and 45° and more preferably between 8 and 35°. According to a preferred variant of the invention, the angle of inclination may be indexed, for example by means of graduations 18 situated on pivoting adjustment disk 14, facing which graduations there corresponds a mark 19 provided on mounting 7 on which wheels 2 are mounted, or vice versa.

According to a second preferred embodiment of the invention, as represented in FIG. 3, spreading means 13 has the form of a spreading piece or mechanism 20 provided to push apart rotary axes 6 of end wheels 2, 7, 8 mounted displaceably along an elongated guide slot 10 made in flank pieces 11, 12 of mounting 7 on which wheels 2 are mounted. An example illustrating the manner in which spreading piece or mechanism 20 pushes rotary shafts 6 of the two wheels 2 apart during its vertical displacement is represented schematically in FIGS. 26 to 28.

According to this second embodiment, in each of its flank pieces 11, 12, mounting 7 preferably has at least one elongated guide slot 21, for example substantially vertical, along which a substantially horizontal binding element 22 is mounted to be displaceable. On this binding element 22 there is mounted at least one spreading piece or mechanism 20, preferably two, and on both sides of end wheels 2, 8, 9. When it or they is or are displaced vertically upward or downward, this spreading piece or mechanism 20 is provided to push at least one displaceable rotary shaft 6 apart.

Preferably spreading piece 20 is shaped as a vertical plate 23, at least one of the longitudinal prolongations of which has a cutout 24 at its end, this cutout 24 being preferably shaped as a vee, whose branches are respectively oriented toward the exterior in such a way as to engage rotary shafts 6 of displaceably mounted end wheels 2, 8, 9 in the apex of the vee. Thus, when spreading piece 13, 20 is displaced vertically downward (FIG. 27) or upward (FIG. 28), the segments of its cutouts 24 act as movement conversion ramps by bearing on rotary shafts 6 of displaceable wheels 2 to push them apart from one another. This movement apart is guided horizontally by guide slots 21 made in flank pieces 11, 12 of mounting 7. When spreading piece 13, 20, for example in the form of plates 23, is no longer urged into vertical displacement, the return to initial position (FIG. 26) takes place automatically by the elastic restoring force originating from kinematic running link 3 stretched over wheels 2. Thus, in normal position of use, displaceable rotary shafts 6 arrive at a stop against the part of guide slots 10 close to the center of flank pieces 11, 12 of mounting 7, for example in the immediate proximity of the tip of the vee of each cutout 24.

It is perfectly possible to envision another means 13 making it possible to push rotary shafts 6 of end wheels 2, 8, 9 apart from the center. As an example, spreading means 13 may be provided with a mechanism of rocker bars or similar elements (not represented) or any other movement conversion means making it possible to push shafts 6 of end wheels 2, 8, 9 apart when it is subjected to a bearing force, especially vertical.

Although one spreading piece or mechanism 13, 20 situated on each side of one-piece running gear 1 on the exterior of flanks 11, 12 of mounting 7 and against these has been represented in the figures, it is perfectly possible to envision mounting each of these spreading pieces or mechanisms 13, 20 on each side of one-piece running gear 1 between shafts 6 of displaceable wheels 2 and flanks 11, 12 of mounting 7.

In the case in which spreading piece or mechanism 13, 20 has the form of a plate-type spreading piece 23 with vee-shaped end cutouts 24, the damping effect obtained is in principle proportional to the aperture angle of the vee of cutout 24. As the aperture angle of the vee increases, the amplitude by which shafts 6 of displaceable wheels 2 are pushed apart becomes smaller and the damping effect becomes weaker (light damping). On the other hand, as the angle of the vee decreases, the amplitude by which displaceable shafts 6 of wheels 2 are pushed apart becomes larger and the damping effect becomes stronger (heavy damping).

FIGS. 15 to 17 represent examples of spreading piece 13, 20 with cutouts 24 having different aperture angles. The aperture angle of cutout 24 of the vee is preferably between 60° and 160°, more preferably between 100° and 130°. As represented in FIG. 15, according to a preferred embodiment, the aperture angle of cutout 24 of the vee is substantially equal to 120°.

Although cutout 24 made in the spreading piece has been represented only in the form of a vee, this cutout 24 may have any other appropriate shape that permits the spreading piece to push the displaceably mounted rotary shafts apart.

Thus the apex part of the vee of cutout 24 may be rounded, as represented in FIG. 29, or else cutout 24 itself may be totally rounded (FIG. 19), thus making it possible to obtain a progressive damping effect. Similarly, cutout 24 is not necessarily symmetric. If it is asymmetric (FIG. 20), it achieves a different damping effect depending on whether spreading piece 13, 20 is being displaced upward or downward.

Regardless of the embodiment of the invention, mounting 7 on which rotary shafts 6 are mounted is preferably composed of two flank pieces 11, 12 assembled and maintained parallel at a fixed distance from one another by appropriate assembly means 25 or is composed of a single piece, for example in the form of a metal plate 26 bent to an inverted U, wherein the two lateral faces constitute its flanks 11, 12.

Appropriate assembly means 25 may comprise horizontal transversal rods 27, which are mounted between the flanks of the mounting, for example with immobilization by screwing, welding, riveting or clamping.

According to a variant of the invention represented in numerous figures, there is provided at least one intermediate running support 28 on or in immediate proximity to internal face 29 of kinematic running link 3 in its lower and/or upper part, which intermediate running support 28 makes it possible to facilitate the passage of kinematic running link 3 between wheels 2 and to maintain it on a rectilinear trajectory.

As an example, this running support 28 has the form of at least one pulley disposed between two wheels 2 in transversal position relative to kinematic running link 3 or mounted to be transversely displaceable relative to this kinematic running link 3. This displacement may be damped by an elastic force provided by a spring (not illustrated). The rotary shaft of this pulley is then guided along two facing and parallel transversal holes.

According to this preferred variant, it is possible to mount running supports 28 on appropriate assembly means 25, for example in the form of horizontal transversal rods 27, which maintain flank pieces 11, 12 of mounting 7 at a fixed distance.

It is possible to envision different variants, wherein the vertical position of one or more running supports 28 may be variable and indexable by means of an appropriate device, for example by means of one or more screws 30 sliding freely in a guide slot 31 after loosening of one or more nuts mounted thereon (FIG. 2).

According to another variant of the invention, the vertical position of a running support 28 may be adjustable or displaceable occasionally by means of a mechanical device 32, which may be controlled, for example, by way of a hydraulic jack 33 (FIGS. 45 and 46), in order to achieve point-like bearing contact useful during the maneuvers. By modifying the vertical position of a running support 28, it is advantageously possible to deform the perimeter of kinematic running link 3 spatially, for example in order to reduce the friction surface between this link 3 and floor 4 to the minimum. Thus the support zone may act as a pivoting point, for example to facilitate pivoting of one-piece running gear 1 upon itself.

It is also possible to mount the rotary shaft of running support 28 in elastic suspension along a guide slot, or to envision mounting one or more running supports 28 on an elastic thrust device, for example a spring, which elastically constrains these running supports 28 on internal face 29 of endless kinematic running link 3.

According to an improved variant, not illustrated, it is possible to envision subjecting means 32 for displacement of the or of one support pulley constituting running support 28 to means 13 causing the shafts of wheels 2 to be spread apart. Thus the movement of the at least one running support 28 may be indexed by an appropriate device 32, which may or may not be a motor or may be associated with the control movement of spreading piece or mechanism 13, 20.

According to one variant of the invention, mounting 7 may have one or more lateral guides on both sides of kinematic running link 3. Examples of mounting 7 provided with lateral guides in its lower part are shown in FIGS. 42 to 44.

According to another variant, the substantially horizontal sliding of the at least one displaceably mounted rotary shaft 6 is adjustable by means of an adjustment mechanism 34, which may be controlled, for example by way of a hydraulic jack 35, as is represented in FIG. 4 in a variant in which the position of two shafts 6 is adjustable.

The latter variants are particularly advantageous in the case in which mobile assembly 5 on which one-piece running gear 1 of the invention is provided for use is a vehicle 36. Thus the stiffness of the suspension of such a vehicle 36 may be adjustable, as may be the support surface of its kinematic running links 3.

In the case in which one-piece running gear 1 of the invention is provided for use in a vehicle 36, it is possible to provide a motor means 37 for at least one of wheels 2. This may be an external motor means 37 (not represented), which drives at least one wheel 2 by way of appropriate kinematics. It is also possible to provide an individual motor means 37 for one wheel, for example in the form of an electric motor wheel M. As represented in FIG. 53, this electric motor 37 may be situated on the exterior of the wheel, or on the interior thereof (FIG. 54). Similarly, in the case of a vehicle 36, it is possible to provide a supplementary suspension 38 for wheels 2.

In general, it is possible to provide a supplementary suspension effect for at least one of wheels 2 of one-piece running gear 1, for example by means of springs or analogous elements 38.

External surface 39 of kinematic running link 3 preferably has a substantially semicylindrical shape, or in other words a substantially semicircular section. Thus the use of a kinematic running link 3 of this type considerably reduces its friction surface relative to floor 4, and this is manifested by greater ease of displacement of one-piece running gear 1 according to the invention. Kinematic running link 3 may also have a curvilinear total section, such as round or oval, wherein external face 39 permits different angles with floor 4 while internal face 29 acts to support rotation over the external face of each wheel 2. For this purpose, wheels 2 are preferably wheels with throat 30 and preferably but not necessarily have an external profile complementary to that of internal face 29 of kinematic running link 3.

In order to ensure that kinematic running link 3 does not drop out of throat 30 of wheels 2 or an intermediate running support 28, especially in the case of large lateral force thereon, internal surface 29 of running link 3 may have a shape of substantially semicircular, trapezoidal, triangular, square, rectangular or other section.

Various examples of sectional shapes for internal surface 29 of kinematic running link 3 are represented in FIGS. 29 to 34, where external surface 39 of kinematic running link 3 has a shape of substantially semicircular or otherwise convex section. In FIGS. 32 to 34, it may be pointed out that external surface 39 of kinematic running link 3 may have a section of radius larger than that of internal surface 29, in such a way that the substantially semicylindrical shape of the running surface has a shoulder bearing on the periphery of the lateral faces of wheels 2.

According to another variant of the invention, internal surface 29 of kinematic running link 3 may be solid (FIG. 35) or may have notches 40 (FIGS. 36 to 38), preferably transversal and regular, the depth of which permits faster and much more silent rotation and deformation of kinematic running link 3. These notches 40 may have different shapes, especially a rectangular (FIG. 30), trapezoidal (FIG. 31) or triangular (FIG. 32) profile. They also increase the overall flexibility of kinematic running link 3 and favor its ability to bend without using a material more flexible and therefore less resistant to wear. Thus it is possible to use a relatively hard kinematic running link 3 without greater plasticity, preferably made of polymeric material and advantageously having a central wire reinforcement 41.

When at least one one-piece running gear 1 of the invention is mounted on a running mobile assembly 5, it may be fixed on the latter by way of substantially horizontal binding element 22, which is mounted displaceably in substantially vertical elongated guide slot 21 made in each of the flank pieces 11, 12 of mounting 7. Thus, in the case of shock or unevenness of the terrain, spreading piece or mechanism 13, 20 mounted on binding element 22 is displaced vertically upward or downward under the effect of the bearing force exerted on floor 4 by running mobile assembly 5 on which one-piece running gear 1 of the invention is mounted. This binding element 22 may be mounted pivotally or in fixed manner on a mobile assembly 5 to form a running base. In the case in which binding element 22 is mounted pivotally, one-piece running gear 1 of the invention can pivot around it, thus making it possible, for example, to displace this mobile assembly 5 easily over sloping terrain or to negotiate a difficult passage, for example when floor 4 is encumbered by pebbles or other obstacles. Advantageously, the pivoting mounting of one-piece running gear 1 of the invention may also make it possible to ascend or descend a staircase. By way of example, FIGS. 51 to 58 represent how a shopping cart 43 equipped with a pair of pivoting running gears 1 according to the invention descends a staircase 42. The advantages of such pivoting mounting for one-piece running gear 1 are numerous, and those given here are merely examples thereof.

A preferred variant of the second embodiment of the invention is represented in FIGS. 11 to 14. It is possible to envision numerous variants for a one-piece running gear 1, wherein at least one shaft 6 of wheel 2 is mounted to be mobile and displaceable by being pushed apart under the action of the vertical displacement of a spreading piece or mechanism 13, 20. Thus FIG. 21 represents a variant of running gear 1 of the invention in which rotary shaft 6 of a single wheel 2 is mounted to be mobile and displaceable by being pushed apart.

It is also possible to envision a running gear 1 provided with more than two wheels 2, which may or may not be aligned. Thus FIG. 22 represents a variant of running gear 1 provided with four aligned wheels 2, wherein rotary shaft 6 of front wheels 2, 8 and rear wheels 2, 9 is mounted to be mobile and displaceable by being pushed apart under the action of the vertical displacement of a spreading piece or mechanism 13, 20.

Similarly, in the case in which running gear 1 is provided with more than two wheels 2, these wheels are not necessarily aligned. It will nevertheless be noted that wheels 2 of a given one-piece gear 1 must generally be situated in the same plane in order to receive a kinematic running link 3 carried in rotation while circulating over them.

In addition, regardless of the number of wheels 2 belonging to running gear 1, flank pieces 11, 12 of mounting 7 may each have any number of substantially vertical guide slots 21. When this number is greater than one, these guide slots 21 ensure better guidance for vertical sliding of spreading piece 13, 20.

By way of example, FIG. 23 represents a running gear 1 provided with three aligned wheels 2, wherein flank pieces 11, 12 of mounting 7 each have two vertical guide slots 21 for better vertical guidance of spreading piece 13, 20.

FIG. 24 represents a running gear 1 provided with three wheels 2 disposed vertically in a triangle, the two wheels 2, 7, 8 of the base being substantially similar to those of running gear 1 represented in FIGS. 3 and 11, whereas third wheel 2, 44, or in other words the top wheel, is mounted to rotate around a fixed shaft above the other two wheels 2, 7, 8. In this figure, third wheel 2, 44 is represented in central position relative to the other wheels 2, 7, 8, but this is not obligatory. According to this variant, endless kinematic running link 3 carried in rotation and in circulation over the three wheels 2, 7, 8, 44 is subjected to less bending during reversal of movement than when it is carried by two wheels 2. This reduces the effects of torsion exerted on it and considerably facilitates the passage of the running link around wheels 2. According to this variant, although substantially horizontal binding element 22 mounted on spreading piece or mechanism 13, 20 is fixed in pivoting manner on a running mobile assembly 5, the entire running gear 1 is able to pivot freely around this binding element 22 forming a pivoting shaft. Nevertheless, by reason of the low position of binding element 22 in this variant, the position represented in FIG. 24 for running gear 1 is that corresponding to the equilibrium position, to which running gear 1 returns automatically after a pivoting movement on itself, for example in the case of a step. It will be noted that this low position for binding element 22 is not obligatory and that it can be situated substantially anywhere within the perimeter bounded by rotary shaft 6 of the three wheels 2, 7, 8, 44.

FIG. 25 represents a running gear 1 provided with three wheels 2 disposed vertically in a triangle, wherein rotary shaft 6 of each of these wheels 2 is mounted to be mobile and displaceable by being pushed apart under the vertical displacement action of the same substantially central spreading piece or spreading mechanism 13, 20. According to this variant, substantially horizontal binding element 22 mounted on spreading piece or mechanism 13, 20 is mounted in pivoting manner on a running mobile assembly 5. Since running gear 1 is symmetric relative to a 2π/3 pivoting axis, binding element 22 is mounted substantially centrally relative to the entire running gear 1, in such a way that, after pivoting by 2π/3 on itself, running gear 1 is situated in an equivalent position. According to this variant, elongated guide slot 21 made in the flank pieces of the mounting has a supplementary branch, in such a way that it forms a three-branch star-type conformation.

Another improvement of the invention consists in mounting rotary shaft 6 of at least one wheel 2 slidingly in an elongated guide slot 10 that additionally has a substantially horizontal supplementary rectilinear part 45, as represented in FIGS. 2 and 4. The indexing of rotary shaft 6 in position in substantially horizontal rectilinear part 45 of guide slot 10 permits adjustment of the tension of running kinematic link 3 around wheels 2 and acts to put running kinematic link 3 in place or to replace it. This indexing is achieved by means of a quick, practical and compact adjustment mechanism 46, for example by means of a cam 47 bearing on rotary shaft 46 of one of wheels 2. This adjustment mechanism 46 may be adapted by the person skilled in the art to any embodiment of the invention.

As explained in the foregoing, one-piece running gear 1 of the invention may be mounted on any mobile assembly 5 instead of and in place of existing wheels 2 thereon in order to constitute a running assembly or a running base.

Thus the invention also relates to any running mobile assembly 5 provided with a chassis supported by running means 1, of which at least one is a one-piece running gear 1 according to the invention and at least one running gear 1 can provide steering.

It may also be applied to any mobile or displaceable furniture items 48 usually mounted on wheels, whether they are interior furniture items, hospital gurneys or beds, service wagons, chairs, armchairs, tables, benches, etc.

Finally, the application of the invention is unlimited, and it may be applied to any mobile assembly 5 usually provided with wheels: supermarket cart, plaything, child stroller, robot, gantry, suitcase, scaffolding, etc.

It is of interest in all fields, and more particularly those of transportation, furnishing, restoration, health, agriculture and mechanical engineering in general.

Sturdy, silent and comfortable on any type of terrain, one-piece running gear 1 of the invention constitutes a novel type of running means that brings a decisive improvement compared with the prior art.

Obviously the invention is not limited to the preferred embodiments described in the foregoing and represented in the different figures, and the person skilled in the art will be able to make numerous modifications thereto and to imagine other variants without going beyond the scope or the framework of the invention.

Similarly, although a one-piece running gear 1 provided with a single endless kinematic running link 3 has been represented in different figures, it is perfectly possible to envision a one-piece running gear 1 provided with two or more of the same, for example by combining a plurality of one-piece running gears 1 according to the invention. In this case, kinematic running links 3 may be aligned one behind the other, or may be situated substantially at the same level, parallel with one another.

1. A one-piece running gear (1) for displacement over a floor (4), comprising:
at least two wheels (2), of which two are end wheels (2,8,9), each aligned and mounted [or carried] to rotate around a shaft (6) carried by a mounting (7) having flank pieces (11,12);
wherein said wheels (2) are kinematically interconnected by an endless kinematic running link (3) having an internal face (29) in contact with said at least two wheels (2) and an external face (39) in contact with the floor (4) so that said one-piece running gear (1) runs over said floor (4) as a result of said kinematic running link (3) being carried in circulation by said at least two wheels (2); and
a spreading device (13) disposed in operative cooperation with at least one rotary shaft (6) of one of said at least two wheels (2) so as to be freely displaced in a guided and damped manner over a predetermined course so that said at least two wheels (2) can be automatically displaced with respect to each other during operation in a spreading manner by said spreading device (13) under the sole effect of a pressure force on the floor (4) and wherein said at least two wheels (2) can undergo a restorative movement as a result of being pulled back together by the binding effect originating from said kinematic running link (3).

2. A one-piece running gear (1) according to claim 1, wherein:
said rotary shaft (6) that is displaced during said operation is displaced along a linear course defined along an elongated guide slot (10) defined within said flank pieces (11,12) of said mounting (7); and
wherein the tension of said endless kinematic running link (3) maintains each displaceable rotary shaft (6) in a pulled-together manner within said elongated guide slot (10) and exerts an elastic resisting and restoring force during said displacement.

3. A one-piece running gear (1) according to claim 1, wherein:
said rotary shaft (6) of each end wheel (2,8,9) is mounted so as to be displaceable during said operation by being spread apart by said spreading device (13) and by being restored by being pulled back together by said kinematic running link (3).

4. A one-piece running gear (1) according to claim 1, wherein:
said elongated guide slot (10) is inclined relative to the horizontal and is defined within said flank pieces (11,12) of said mounting (7).

5. A one-piece running gear (1) according to claim 4, wherein:
said elongated guide slot (10) is inclined relative to the horizontal at an angle of inclination within the range of 0 and 90°.

6. A one-piece running gear (1) according to claim 5, wherein:
said angle of inclination of said elongated guide slot (10) is within the range of 0 and 45°, and is preferably within the range of 8 and 35°.

7. A one-piece running gear (1) according to claim 5, wherein:
said angle of inclination of said elongated guide slot (10) can be adjusted by means of a rotatable adjustment disk (14) for achieving adjustable inclination, and a guide slot (15) provided for the passage of said rotary shaft (6) to be displaced by sliding along said guide slot (15), said rotary shaft (6) also being disposed within an enlarged guide slot (10,13) defined within said flank pieces (11,12) of said mounting (7).

8. A one-piece running gear (1) according to claim 2, wherein:
the disposition of said elongated guide slot (10) defined within said flank pieces (11,12) of said mounting (7) is indexed by means of a quick adjustment mechanism (46).

9. A one-piece running gear (1) according to claim 2, wherein:
said spreading device (13) comprises a spreading mechanism (20) which is adapted to push the displaceable rotary shafts (6) apart along the elongated guide slot (10) defined within said flank pieces (11,12) of said mounting (7) under the effect of a force bearing on the floor (4).

10. A one-piece running gear (1) according to the claim 9, wherein:
said spreading mechanism (20) is adapted to displace at least one displaceable rotary shaft (6) of one of said wheels (2) by pushing it apart from the other rotary shaft (6) when said spreading mechanism (20) is actuated by a force.

11. A one-piece running gear (1) according to the claim 10, wherein:
said actuating force originates from the force with which said one-piece running gear (1) bears upon the floor (4).

12. A one-piece running gear (1) according to claim 9, wherein:
said mounting (7) has, in each one of said flank pieces (11,12), at least one elongated guide slot (21) in which a binding element (22) is mounted to be displaceable transversely relative to the entire one-piece running gear (1), said binding element being connected to at least one spreading mechanism (20).

13. one-piece running gear (1) according to claim 12, wherein:
two spreading mechanisms (20) are mounted in parallel on said binding element (22) on both sides of said end wheels (2,8,9).

14. A one-piece running gear (1) according to claim 9, wherein:
said spreading piece (20) comprises an elongated plate (23), at least one of the longitudinal ends of which has a cutout (24) for applying a force to one of said rotary shafts (6) of said end wheels (2,8,9) in order to displace one of said end wheels (2,8,9) relative to the other one of said end wheels (2,8,9) by an oblique ramp effect during the relative displacement of the spreading mechanism (20) relative to said mounting (7).

15. A one-piece running gear (1) according to claim 14, wherein:
said cutout (24) is shaped like a vee whose branches are respectively oriented toward the exterior in such a way as to engage said displaceable rotary shafts (6) of said end wheels (2,8,9) in the apex of the vee in a rest position.

16. A one-piece running gear (1) according to claim 15, wherein:
said vee-shaped cutout (24) has an angular extent which is between 60° and 160° and is preferably equal to 120°.

17. A one-piece running gear (1) according to claim 15, wherein:
said cutout (24) of said vee is rounded such that said vee-shaped cutout (24) has an arcuate configuration which is substantially that of a semi-circle.

18. A one-piece running gear (1) according to claim 2, wherein:
said elongated guide slot (10) additionally has a substantially horizontal rectilinear part (45) along which at least one of said displaceable rotary shafts (6) is mounted so as to slide substantially horizontally.

19. A one-piece running gear (1) according to claim 18, wherein:
the disposition of said rotary shaft (6) within said substantially horizontal rectilinear slot (45) is indexed by means of an adjusting mechanism (34,46).

20. A one-piece running gear (1) according to claim 19, wherein:
said adjusting mechanism (46) comprises a cam (47) bearing on said rotary shaft (6) of one of said wheels (2).

21. A one-piece running gear (1) according to claim 19, wherein:
said adjusting mechanism (34) is controlled by means of a hydraulic jack (35).

22. A one-piece running gear (1) according to claim 1, further comprising:
at least one intermediate running support (28), interposed between said at least two wheels (2) in proximity to said internal face (29) of said kinematic running link (3), and in the form of at least one running element.

23. (canceled)

24. A one-piece running gear (1) according to claim 22, wherein:
said at least one intermediate running support (28) is movably mounted within said one-piece running gear (1) and relative to said at least two wheels (2); and
said movement of said at least one running support (28) is indexed by means of an appropriate movement control device (32).

25. A one-piece running gear (1) according to claim 24, wherein:
said movement control device (32) comprises a hydraulic jack (33).

26. A one-piece running gear (1) according to claim 1, wherein:
at least one of said at least two wheels (2) is provided with a drive motor (37).

27. A one-piece running gear (1) according to claim 1, wherein:
said external surface (39) of said kinematic running link (3) has a substantially convex configuration.

28. A one-piece running gear (1) according to claim 1, wherein:
said internal surface of said kinematic running link (3) has a substantially convex configuration; and
said at least two wheels (2) throats (30) which have configurations which correspond to said configuration of said internal surface (29) of said kinematic running link (3).

29. A one-piece running gear (1) according to claim 1, wherein:
said internal surface (29) of kinematic running link (3) has a configuration which is selected from the group comprising a semicircular, trapezoidal, triangular, square and rectangular cross-sectional configuration.

30. A one-piece running gear (1) according to claim 1, wherein:
said external surface (39) of said kinematic running link (3) has an arcuate section with a radius greater than that of said internal surface (29).

31. A one-piece running gear (1) according to claim 1, wherein:
said internal surface (29) of said kinematic running link (3) is provided with a plurality of notches (40).

32. A one-piece running gear (1) according to claim 1, wherein:
said mounting (7) has at least one lateral guide disposed upon each side of said kinematic running link (3).

33. A one-piece running gear (1) according to claim 1, wherein:
said spreading device (13) is provided with a movement-conversion mechanism making it possible to push said rotary shafts of said end wheels (2,8,9) apart when said movement-conversion mechanism is subjected to a force originating from bearing on the floor (4).

34. (canceled)

35. (canceled)

36. A one-piece running gear (1) according to claim 1, wherein:
said one-piece running gear (1) is provided with three wheels (2) disposed with a vertically oriented array as a triangle wherein said rotary shafts (6) of the two bottom wheels (2,8,9) of said three-wheel triangular array are mounted so as to be displaceable by being pushed apart by means of said at least one spreading device (13), while the third upper wheel (2,44) said three-wheel triangular array is mounted so as to rotate around a fixed shaft (6).

37. A one-piece running gear (1) according to claim 1, wherein:
all three wheels (2) disposed within said triangular array have said rotary shafts (6) mounted in such a manner as to be displaceable by a substantially centrally located spreading device (13).

38. (canceled)

39. A running mobile assembly (5) for movement along a surface, comprising:
a chassis;
at least two one-piece running gears mounted upon said chassis, wherein each one of said at least two one-piece running gears (1) comprises at least two wheels (2) rotatably mounted upon shafts (6) carried by a mounting (7) having flank pieces (11,12), and wherein said at least two wheels (2) are kinematically interconnected by means of an endless kinematic running link (3) having an internal face (29) in contact with said at least two wheels (2), and an external face (39) in contact with the surface so that said at least two one-piece running gears (1) run over the surface as a result of said kinematic running link (3) being carried in circulation by said at least two wheels (2), and wherein at least one of said at least two one-piece running gears can provide steering for said running mobile assembly (5); and
a spreading device (13) disposed in operative cooperation with at least one rotary shaft (6) of one of said at least two wheels (2) so as to be freely displaced in a guided and damped manner over a predetermined course so that said at least two wheels (2) can be automatically displaced with respect to each other during operation in a spreading manner by said spreading device (13) under the sole effect of a pressure force on the surface and wherein said at least two wheels (2) can undergo a restorative movement as a result of being pulled back together by the binding effect originating from said kinematic running link (3).

40. A running mobile assembly (5) according to claim 39, wherein:
said at least two one-piece running gears (1) are fixedly mounted upon said running mobile assembly (5) by means of binding elements (22).

41. A running mobile assembly (5) according to claim 39, wherein:
said at least two one-piece running gears are pivotally mounted upon said running mobile assembly (5) so as to enable said running mobile assembly (5) to ascend and descend stairs.
